(19) United States
(12) Patent Application Publication
(10) Pub. No.: US 2025/0284183 A1
(43) Pub. Date: Sep. 11, 2025

(54) MULTI-CAMERA ASSEMBLY

(71) Applicant: HANWHA VISION CO., LTD., Seongnam-si (KR)

(72) Inventors: Dae Kyung KIM, Seongnam-si (KR); Kil Hwa HONG, Seongnam-si (KR); Tae Kyun CHANG, Seongnam-si (KR); Sung Min KANG, Seongnam-si (KR)

(73) Assignee: HANWHA VISION CO., LTD., Seongnam-si (KR)

(21) Appl. No.: 19/075,354

(22) Filed: Mar. 10, 2025

(30) Foreign Application Priority Data
Mar. 11, 2024 (KR) 10-2024-0033937

(51) Int. Cl. G03B 17/56; G03B 17/02

(52) U.S. Cl. CPC G03B 17/561; G03B 17/02

(57) ABSTRACT

A multi-camera assembly may be provided and include: camera modules; fan frames configured to tiltably support the camera modules, respectively; a bottom frame configured to rotatably support the fan frames in a panning direction of the camera modules, the bottom frame including a cylindrical support portion in a central region of the bottom frame; and connection portions between the fan frames and the support portion, the connection portions configured to connect the fan frames and the support portion.

### CROSS-REFERENCE TO RELATED APPLICATION

This application claims priority from Korean Patent Application No. 10-2024-0033937, filed on Mar. 11, 2024, in the Korean Intellectual Property Office, and all the benefits accruing therefrom under 35 U.S.C. 119, the disclosure of which is herein incorporated by reference in its entirety.

### BACKGROUND

### 1. Field

The present disclosure relates to a multi-camera assembly and, more specifically, to a multi-camera assembly in which fan frames supporting respective camera modules can be individually attached and detached by improving an assembly structure.

### 2. Description of Related Art

In general, surveillance cameras for monitoring a specific area may be equipped with a plurality of camera modules having pan/tilt/zoom movements to cover a wide area with a small number of devices and track objects exhibiting specific movements. In particular, among various types of surveillance cameras, dome cameras have been increasingly used because their circularly symmetric shape around the central axis facilitates pan/tilt/zoom movements and enables miniaturization.

Such surveillance cameras may include a dome cover, which is a transparent optical exterior component configured to cover multiple cameras, and fans mounted inside the dome cover to direct air onto the inner surface of the dome cover, thereby preventing fogging or condensation. Specifically, a dome camera may be provided with a plurality of blower fans in the vicinity of multiple camera modules arranged along the circumferential direction of a housing, as well as multiple intake ports and exhaust ports.

The blower fans may be used to remove moisture generated due to a temperature difference between an interior and an exterior of the dome camera or to cool down the camera modules or circuit boards that may overheat depending on installation or usage environment.

Additionally, the dome cover may include a transparent panel that transmits reflected light from a subject to the camera modules, and a transmission panel that transmits infrared rays emitted from an illumination module. Since the transparent panel and the transmission panel may be made of different materials or formed in different shapes, they may be separately manufactured and then assembled before being mounted on the housing.

However, in a surveillance camera of a background embodiment, fan frames are merely rotatably coupled to a bottom frame, meaning that removing a single fan frame that needs to be replaced requires the disassembly of multiple fan frames, which is inconvenient.

### SUMMARY

According to embodiments of the present disclosure, a multi-camera assembly may be provided in which fan frames supporting respective camera modules can be individually attached and detached by improving an assembly structure.

According to embodiments of the present disclosure, a multi-camera assembly may be provided and include: camera modules; fan frames configured to tiltably support the camera modules, respectively; a bottom frame configured to rotatably support the fan frames in a panning direction of the camera modules around a vertical axis of the bottom frame, and the bottom frame includes a cylindrical support portion in a central region of the bottom frame; and connection portions between the fan frames and the cylindrical support portion, the connection portions configured to connect the fan frames and the cylindrical support portion.

According to one or more embodiments of the present disclosure, each of the connection portions includes: a ring member configured to surround an outer circumferential surface of the cylindrical support portion; and a first fastening member extending from one side of the ring member and coupled with one of the fan frames.

According to one or more embodiments of the present disclosure, the fan frames include a first fan frame and a second fan frame, wherein the connection portions include a first connection portion and a second connection portion, the first connection portion configured to connect the first fan frame and the cylindrical support portion, and the second connection portion configured to connect the second fan frame and the cylindrical support portion, and wherein the first fan frame and the second fan frame overlap each other on the outer circumferential surface of the cylindrical support portion.

According to one or more embodiments of the present disclosure, the first fastening member of the first connection portion and the first fastening member of the second connection portion are at respective, different angles around a central axis of the cylindrical support portion, the central axis being parallel to the vertical axis.

According to one or more embodiments of the present disclosure, the first connection portion and the second connection portion are coupled to the cylindrical support portion at respective, different heights based on heights at which the ring member of the first connection portion and the ring member of the second connection portion are coupled to the cylindrical support portion.

According to one or more embodiments of the present disclosure, each of the fan frames includes: a coupling portion that is coupled to one of the connection portions; and side portions extending from respective ends of the coupling portion and face each other to form a tilting axis of a corresponding one of the camera modules.

According to one or more embodiments of the present disclosure, the coupling portion includes a second fastening member that is configured to face and be coupled to the first fastening member.

According to one or more embodiments of the present disclosure, the coupling portion further includes a third fastening member that partially overlaps the second fastening member of the coupling portion in a height direction of the multi-camera assembly, wherein the third fastening member is configured to face and be coupled to the first fastening member.

According to one or more embodiments of the present disclosure, the first fastening member and the second fastening member are configured to be coupled to each other via a fastener, in a state where the first fastening member and the second fastening member overlap each other in a height direction of the multi-camera assembly and are at a side of the cylindrical support portion in a radial direction of the cylindrical support portion.

According to one or more embodiments of the present disclosure, the third fastening member of the coupling portion is exposed outside of the second fastening member of the coupling portion in the radial direction, and the third fastening member includes a fastening region that is configured to be coupled to the first fastening member without interfering with the second fastening member.

According to one or more embodiments of the present disclosure, the second fastening member and the third fastening member have a thickness that is the same as a thickness of the first fastening member.

According to one or more embodiments of the present disclosure, the first fastening member is configured to be selectively coupled to either an upper surface or a lower surface of the second fastening member or an upper surface or a lower surface of the third fastening member.

According to one or more embodiments of the present disclosure, the fan frames include a first fan frame and a second fan frame, wherein the connection portions include a first connection portion and a second connection portion, the first connection portion configured to connect the first fan frame and the cylindrical support portion, and the second connection portion configured to connect the second fan frame and the cylindrical support portion, and wherein the first fastening member of the first connection portion is configured to be coupled to the second fastening member or the third fastening member of the coupling portion of the first fan frame, and the first fastening member of the second connection portion is configured to be coupled to the second fastening member or the third fastening member of the coupling portion of the second fan frame, such that the first fan frame and the second fan frame are at a same height.

According to one or more embodiments of the present disclosure, each connection portion from among the connection portions includes extension members extending in a vertical direction from respective sides of the first fastening member of the connection portion, and wherein the vertical direction is parallel to the vertical axis, and the respective sides are horizontally spaced apart from each other around the vertical axis.

According to one or more embodiments of the present disclosure, the extension members of one of the connection portions are configured to interfere with the extension members of at least one other connection portion from among the connection portions, and wherein the extension members of the least one other connection portion are in the panning direction with respect to the extension members of the one of the connection portions.

According to one or more embodiments of the present disclosure, the extension members of the one of the connection portions include inclined surfaces, and wherein a spacing between the inclined surfaces decreases in a direction in which the one of the connection portions is coupled to the coupling portion of one of the fan frames.

According to one or more embodiments of the present disclosure, opposite side end portions of the second fastening member or the third fastening member are chamfered to correspond to a slope of the inclined surfaces.

According to embodiments of the present disclosure, a multi-camera assembly may be provided and include: a first camera module; a second camera module; a first frame configured to tiltably support the first camera module; a second frame configured to tiltably support the second camera module; a bottom frame configured to rotatably support the first fan frame and the second fan frame in a panning direction of the first camera module and the second camera module around a vertical axis of the bottom frame, and the bottom frame including a cylindrical support portion in a central region of the bottom frame; a first connection portion between the first frame and the cylindrical support portion, the first connection portion configured to connect the first frame and the cylindrical support portion; and a second connection portion between the second frame and the cylindrical support portion, the second connection portion configured to connect the second frame and the cylindrical support portion.

According to one or more embodiments of the present disclosure, each of the first connection portion and the second connection portion includes: a ring member configured to surround an outer circumferential surface of the cylindrical support portion; and a first fastening member extending from one side of the ring member and coupled with the first frame or the second frame.

According to embodiments of the present disclosure, a method of assembling a multi-camera assembly may be provided and include: tiltably supporting camera modules on fan frames, respectively; rotatably supporting, in a panning direction of the camera modules, the fan frames on a bottom frame, the bottom frame including a cylindrical support portion in a central region of the bottom frame; and connecting the fan frames to the cylindrical support portion via connection portions, the connection portions being between the fan frames and the cylindrical support portion.

Aspects and effects of embodiments of the present disclosure are not limited to the aspects and effects described above, and other aspects and effects of embodiments of the present disclosure will be clearly understood by those skilled in the art based on the following description.

### BRIEF DESCRIPTION OF DRAWINGS

The following detailed description and the summary above will be better understood when read in conjunction with the accompanying drawings. The drawings illustrate non-limiting example embodiments of the present disclosure. However, it should be understood that the present application is not limited to the example embodiments.

FIG. 1 is a perspective view illustrating a multi-camera assembly according to an embodiment of the present disclosure.

FIG. 2 is an exploded perspective view illustrating the multi-camera assembly of FIG. 1 in a disassembled state.

FIG. 3 is a cross-sectional view taken along a line I-I′ of the multi-camera assembly of FIG. 1.

FIG. 4 is a perspective view illustrating a connection portion of the multi-camera assembly of FIG. 3.

FIG. 5 is a perspective view illustrating a fan frame of the multi-camera assembly of FIG. 2.

FIG. 6 is a plan view illustrating the fan frame of FIG. 5.

FIG. 7 is a reference diagram illustrating a coupled state of fan frames and connection portions of the multi-camera assembly of FIG. 2.

FIG. 8 is a reference diagram illustrating a coupled state of the connection portions mounted on a support portion.

### DETAILED DESCRIPTION

Non-limiting example embodiments of the present disclosure will hereinafter be described in detail with reference to the accompanying drawings. Advantages, features, and methods for achieving the same in the present disclosure will become apparent by referring to the example embodiments described below along with the accompanying drawings. However, the present disclosure is not limited to the example embodiments set forth below and embodiments of the present disclosure may be implemented in various other forms. The following example embodiments are provided to fully describe the present disclosure and to fully convey the scope of the present disclosure to those skilled in the art. Throughout the specification, the same reference numerals denote the same components.

It should be understood that the present disclosure includes all modifications, equivalents, and alternatives within the spirit and scope of the present disclosure.

Terms including ordinal numbers such as “first,” “second,” etc., may be used to describe various components, but these components are not limited by these terms. These terms are used only to distinguish one component from another. For example, a second component can be named a first component without departing from the scope of the present disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present. Conversely, when a component is said to be “directly connected to” or “directly coupled to” another component, there are no intervening components.

The terms used in this application are for the purpose of describing example embodiments only and are not intended to limit the present disclosure.

Unless the context clearly indicates otherwise, the singular forms include the plural forms as well.

In this application, the terms “comprising,” “including,” and “having” are intended to specify the presence of stated features, numbers, steps, operations, elements, components, or combinations thereof, but do not preclude the presence or addition of one or more other features, numbers, steps, operations, elements, components, or combinations thereof.

Non-limiting example embodiments will hereinafter be described with reference to the accompanying drawings, wherein the same or corresponding components, regardless of the drawing numbers, are assigned the same reference numbers, and redundant descriptions may be omitted.

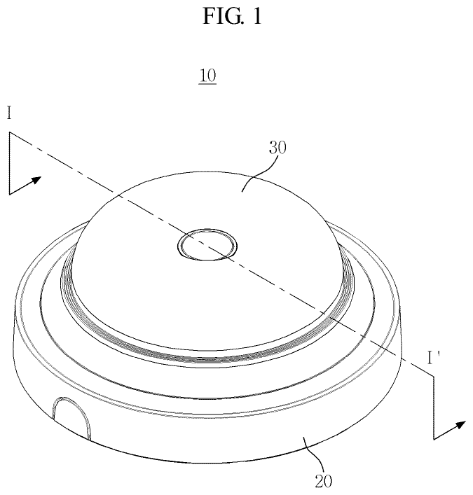

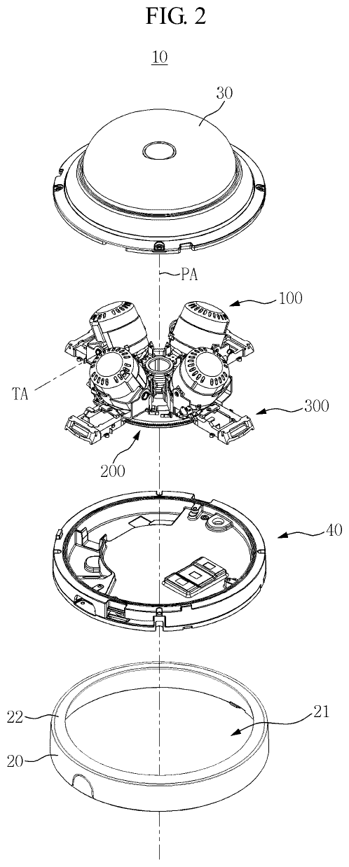

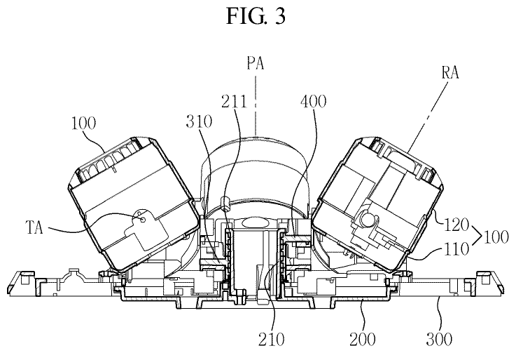

FIG. 1 is a perspective view illustrating a multi-camera assembly according to an embodiment of the present disclosure, FIG. 2 is an exploded perspective view illustrating the multi-camera assembly of FIG. 1 in a disassembled state, and FIG. 3 is a cross-sectional view taken along a line I-I′ of the multi-camera assembly of FIG. 1.

Referring to FIGS. 1 through 3, a multi-camera assembly 10 may include a housing 20, a plurality of camera modules 100, a dome cover 30, a bottom frame 200, fan frames 300, and connection portions 400.

In FIGS. 1 through 3, the dome cover 30 is illustrated as being positioned at the top of the multi-camera assembly 10, and when the multi-camera assembly 10 is installed on a mounting surface, the dome cover 30 may be positioned facing downward. Accordingly, the upper and lower directional designations may be reversed depending on the installation position.

The housing 20 may be formed to cover the perimeter of the multi-camera assembly 10 along a substantially circumferential direction. The housing 20 may have a predetermined height, and form an accommodation space 21 inside. The housing 20 may be bent inward along the circumferential direction, forming a step 22 on one side thereof. The outer end of the dome cover 30 and a support frame 40 may be assembled on the step 22, surrounding (e.g., covering) all of the camera modules 100.

The support frame 40 may be coupled within the accommodation space 21 of the housing 20. A circuit board and the like may be mounted on the support frame 40.

The bottom frame 200 may be fixed on the support frame 40. The bottom frame 200 may be positioned inside the accommodation space 21.

In addition, illumination modules may be arranged along the outer circumferential edge of the bottom frame 200.

A cylindrical support portion 210 may be provided at the center of the bottom frame 200. The cylindrical support portion 210 may be installed to protrude upward from the center of the bottom frame 200. A flange member 211 may be formed at an upper part of the support portion 210 to support a coupling portion joined to the support portion 210, preventing the coupling portion from being detached. Further, the support portion 210 may be positioned between the camera modules 100, at the center of the bottom frame 200, while being centered around a panning axis PA. The support portion 210 may be fastened to the central region of the bottom frame 200 through a fastener.

The fan frames 300 may be arranged on the bottom frame 200 to support a plurality of camera modules 100, enabling the camera modules 100 to tilt and pan on the bottom frame 200. Illumination modules may be mounted on the outer front ends of the fan frames 300.

Here, the camera modules 100 may perform tilting/panning/rotation movements.

Tilting refers to the function in which the camera modules 100 rotate upward/downward around a tilting axis TA, which may be formed in a horizontal direction on the fan frames 300, to adjust their inclination. For example, the tilting angle may range from 0 to 90 degrees.

Panning refers to the function in which the camera modules 100, together with the fan frames 300, rotate clockwise or counterclockwise around the panning axis PA, which is formed in a vertical direction to correspond to the center of the bottom frame 200. For example, the panning angle may range from 0 to 360 degrees.

Rotation refers to the function in which the camera modules 100 rotate on the fan frames 300. For example, the rotation angle may range from 0 to 90 degrees.

For example, as illustrated in FIGS. 1 through 3, four camera modules 100 and four illumination modules may be provided along with four fan frames 300 that mount the four camera modules 100, respectively, but embodiments of the present disclosure are not limited thereto. That is, the numbers of camera modules 100 and fan frames 300 may be variously adjusted.

Accordingly, each camera module 100 may perform panning around the panning axis PA, moving closer to or farther from an adjacent one of the camera modules 100 on one side or an opposite side of the camera module 100.

Each of the camera modules 100 may include a tilt frame 110 and a front cover 120.

The tilt frames 110 of the camera modules 100 may be coupled to the fan frames 300 to enable tilting around the tilting axis TA.

The front covers 120 of the camera modules 100 may be positioned on the tilt frames 110. In this case, the front covers 120 may be coupled onto the tilt frames 110 to be rotatable relative to the tilt frames 110.

The camera modules 100 may rotate around a rotation axis RA of the front cover 120. For example, the function of adjusting image inversion based on the shooting direction or correcting horizontal alignment may be provided through the rotation of the front covers 120 when the installation of the multi-camera assembly 10 is complete.

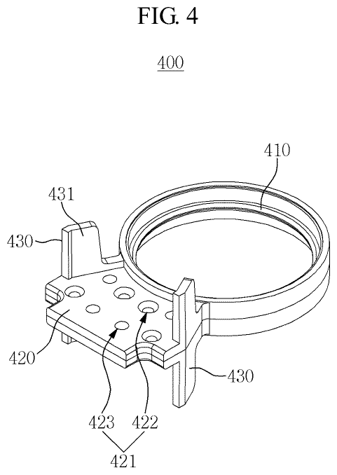

FIG. 4 is a perspective view illustrating a connection portion of the multi-camera assembly of FIG. 3.

Referring to FIG. 4, a connection portion 400 may include a ring member 410, a first fastening member 420 (e.g., a first fastener body), and extension members 430.

The ring member 410 may be coupled (e.g., to the cylindrical support portion 210) to surround the outer circumferential surface of the cylindrical support portion 210. The ring member 410 may have a hollow circular frame structure at one cross-section and may be arranged to be rotatable on the support portion 210. Accordingly, as illustrated in FIG. 3, a plurality of ring members 410 may be coupled to overlap each other along the panning axis PA, which may correspond to the height direction of the cylindrical support portion 210.

Additionally, the first fastening member 420 may protrude in a radial direction from the ring member 410 (e.g., from an outer circumferential surface of the ring member 410), and a fan frame 300 may be coupled to the first fastening member 420. In this case, the first fastening member 420 may be positioned on a same horizontal plane as the ring member 410 in the height direction of the support portion 210. A plurality of first fastening members 420 may be arranged at different angles from corresponding ones of the ring members 410, respectively, with respect to the central height direction (e.g., the panning axis PA or a central axis of the support portion 210) of the support portion 210 of FIG. 2. That is, according to some embodiments, the plurality of first fastening members 420 may be arranged around the panning axis PA so as not to overlap each other along the panning axis PA of the support portion 210.

Further, the extension members 430 may extend to protrude (e.g., vertically protrude in a direction parallel to the panning axis PA) from respective sides of the first fastening member 420, the respective sides being in a direction around the panning axis PA of the support portion 210. Since the first fastening members 420 of the connection portions 400 are arranged so as not to overlap (e.g., vertically overlap) each other along the panning axis PA of the support portion 210, when the connection portions 400 rotate along the panning direction on the support portion 210, the extension members 430 provided on one of the first fastening members 420 may come into contact with the extension members 430 provided on another first fastening member 420. Accordingly, when two connection portions 400 rotate closer in the panning direction, their panning rotation may be restricted by interference between the extension members 430. This also prevents direct collisions between fan frames 300, ensuring impact is not transmitted to the camera modules 100.

Also, the extension members 430 may be spaced from each other in a direction that is parallel to the circumferential direction of the ring member 410. Accordingly, the extension members 430 positioned on either side of one first fastening member 420 may be may be inclined toward the center of the support portion 210, and inclined surfaces 431 of the extension members that are inclined toward the center of the cylindrical support portion 210 may be arranged at either end of the first fastening member 420. The inclined surfaces 431 may be formed to gradually narrow in spacing therebetween in the coupling direction of the fan frame 300 to the connection portion 400. When one connection portion 400 pans, its extension members 430 may face and come into contact with the extension members 430 of another adjacent one of the connection portions 400.

Additionally, a plurality of fastening holes 421 may be formed along the circumferential direction of the ring member 410 in the first fastening member 420. The fastening holes 421 may be arranged in separate regions along different radii in the circumferential direction of the ring member 410. For example, the fastening holes 421 of the first fastening member 420 may include first fastening holes 422 arranged along a first radius of the ring member 410, and second fastening holes 423 arranged along a second radius further from the inside of the ring member 410. Additional details regarding the fastening holes 421 will be described later.

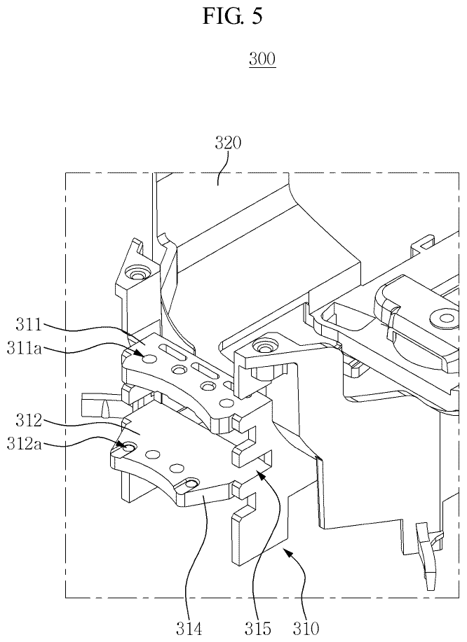

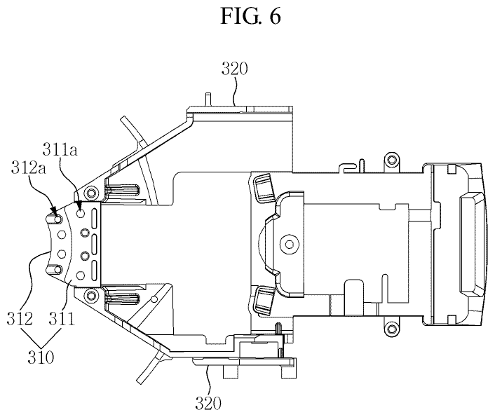

FIG. 5 is a perspective view illustrating a fan frame of the multi-camera assembly of FIG. 2, and FIG. 6 is a plan view illustrating the fan frame of FIG. 5.

Referring to FIGS. 5 and 6, a fan frame 300 may include a coupling portion 310 and side portions 320.

First, the coupling portion 310 may be arranged to face the support portion 210 and may be fastened onto a connection portion 400.

The coupling portion 310 may include a second fastening member 311 (e.g., a second fastener body) and a third fastening member 312 (e.g., a third fastener body).

The coupling portion 310 may be arranged along the panning axis PA of the support portion 210 and positioned on the inner side of the fan frame 300. Additionally, one of the second fastening member 311 or the third fastening member 312 may be selectively coupled to the first fastening member 420.

On the coupling portion 310, the second fastening member 311 may be positioned higher than the third fastening member 312 along the panning axis PA of the support portion 210. The coupling portion 310 may be formed so that the heights (or thicknesses) of the second fastening member 311 and the third fastening member 312 are the same as the height (or thickness) of the first fastening member 420.

With respect to the direction of the panning axis PA of the support portion 210, fourth fastening holes 312a may be formed in the third fastening member 312 at positions not overlapping with third fastening holes 311a in the second fastening member 311. A fastener (e.g., a screw or a bolt) may be inserted into each of the third fastening hole 311a or the fourth fastening hole 312a to penetrate the first fastening member 420 and either the second fastening member 311 or the third fastening member 312 when the first fastening member 420 and either the second fastening member 311 or the third fastening member 312 are positioned to overlap and face each other.

The side portions 320 may extend from respective ends of the coupling portion 310 to face each other and support a camera module 100 to form the tilting axis TA of the camera module 100.

Chamfered sections 314 may be formed on at least one side end portion of each of the second fastening member 311 and the third fastening member 312 to correspond to the slope of the inclined surfaces 431 of the connection portion 400.

Additionally, a front end of the coupling portion 310, that faces the support portion 210, may include a curved surface corresponding to the outer circumferential surface of the ring member 410 of the connection portion 400, and the coupling portion 310 may thereby be spaced apart from the ring member 410.

Furthermore, the coupling portion 310 may have a plurality of grooves 315 formed between the second fastening member 311 and the third fastening member 312, into which the first fastening member 420 may be partially inserted when the connection portion 400 is coupled to the coupling portion 310.

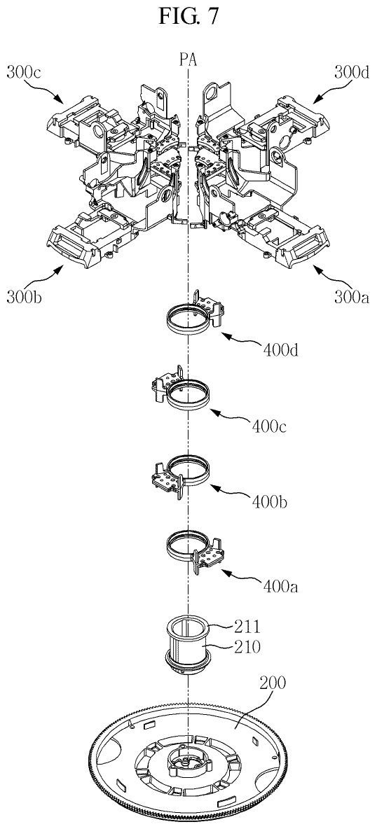

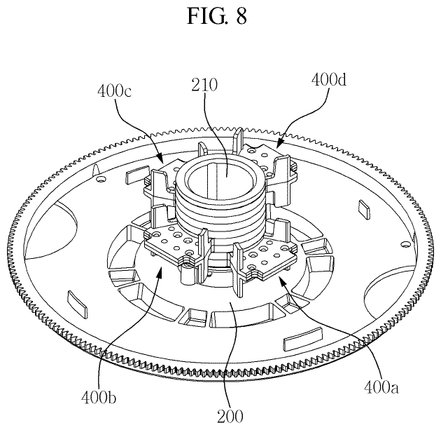

FIG. 7 is a reference diagram illustrating a coupled state of the fan frames and connection portions of the multi-camera assembly of FIG. 2, and FIG. 8 is a reference diagram illustrating a coupled state of the connection portions mounted on the support portion.

Referring to FIGS. 7 and 8, the second fastening member 311 and the third fastening member 312 of each fan frame 300 may be arranged to face or overlap with the first fastening member 420 of a respective one of the connection portions 400. The coupling portion 310 may be coupled such that either the second fastening member 311 or the third fastening member 312 may be coupled to the first fastening member 420.

For example, the second fastening member 311 may include third fastening holes 311a that correspond to the second fastening holes 423, at the second radius, of the first fastening member 420. Additionally, the third fastening member 312 may include fourth fastening holes 312a that correspond to the first fastening holes 422, at the first radius, of the first fastening member 420.

That is, the third fastening holes 311a may be formed in a row along the second radius from the center of the support portion 210, in the second fastening member 311, and the fourth fastening holes 312a may be formed in a row along the first radius from the center of the support portion 210, in the third fastening member 312.

As illustrated in FIG. 6, the fourth fastening holes 312a may be exposed outside the second fastening member 311 from a planar perspective. In other words, the third fastening member 312 may be exposed outside the second fastening member 311, and may include a fastening region that is relatively closer than the second fastening member 311 to the ring member 410. Accordingly, when fasteners are coupled into the fourth fastening holes 312a in the fastening region of the third fastening member 312, they may be inserted so as to not interfere with the second fastening member 311. The coupling direction of the fasteners may correspond to the direction of the panning axis PA of the support portion 210.

Through this, even if one of the second fastening member 311 or the third fastening member 312 is coupled with the first fastening member 420, the fan frame 300 can be selectively attached to or detached from a respective one of the connection portions 400, thereby facilitating maintenance.

For example, a first fan frame 300a may be coupled to a first connection portion 400a, which is assembled at a first level (e.g., a first vertical level) on the support portion 210, and a second fan frame 300b may be coupled to a second connection portion 400b, which is assembled at a second level (e.g., a second vertical level) on the support portion 210, above the first connection portion 400a on the support portion 210. Similarly, a third fan frame 300c may be coupled to a third connection portion 400c at a third level (e.g., a third vertical level) on the support portion 210, and a fourth fan frame 300d may be coupled to a fourth connection portion 400d at a fourth level (e.g., a fourth vertical level) on the support portion 210. The heights at which the first through fourth fan frames 300a through 300d are coupled to the first through fourth connection portions 400a through 400d, respectively, may differ, but the heights of the first through fourth fan frames 300a through 300d from the bottom frame 200 may all be the same.

The first fastening member 420 of the first connection portion 400a and the third fastening member 312 of the first fan frame 300a may be fastened by coupling fasteners into the innermost holes of the fourth fastening holes 312a, the first fastening member 420 of the second connection portion 400b and the third fastening member 312 of the second fan frame 300b may be fastened by coupling fasteners into the outermost holes of the fourth fastening holes 312, the first fastening member 420 of the third connection portion 400c and the second fastening member 311 of the third fan frame 300c may be fastened by coupling fasteners into the outermost holes of the third fastening holes 311a, and the first fastening member 420 of the fourth connection portion 400d and the second fastening member 311 of the fourth fan frame 300d may be fastened by coupling fasteners into the innermost holes of the third fastening holes 311a. That is, the first connection portion 400a and the second connection portion 400b, which are coupled at the first and second levels on the support portion 210, may be fastened through the fourth fastening holes 312a of the third fastening member 312, which are exposed outside the second fastening members 311 of the first fan frame 300a and the second fan frame 300b, and the third connection portion 400c and the fourth connection portion 400d, which are coupled at the third and fourth levels on the support portion 210, may be fastened through the third fastening holes 311a of the second fastening members 311 of the third fan frame 300c and the fourth fan frame 300d. In this manner, the first through fourth fan frames 300a through 300d can be attached and detached selectively and individually.

The first fastening members 420 may be fastened to the upper or lower surfaces of the second fastening members 311 via fasteners. Additionally, the first fastening members 420 may also be selectively fastened to the upper or lower surfaces of the third fastening members 312 via fasteners.

According to the multi-camera assembly of the present embodiment, the fan frames may be rotatably supported on the support portion while also being individually detachable. By improving the assembly structure of the connection portions and the coupling portions, interference occurring during the assembly of each of the fan frames to the corresponding connection portions can be minimized. Furthermore, by providing extension members on each connection portion, the transmission of impact to the camera modules due to contact during panning can be reduced.

While non-limiting example embodiments of the present disclosure have been described with reference to the accompanying drawings, the present disclosure is not limited to the specific configurations and operations described herein. Various modifications may be implemented without departing from the scope of the present disclosure. Therefore, such modifications should be considered to be within the scope of the present disclosure.

What is claimed is:

1. A multi-camera assembly comprising:
camera modules;
fan frames configured to tiltably support the camera modules, respectively;
a bottom frame configured to rotatably support the fan frames in a panning direction of the camera modules around a vertical axis of the bottom frame, and the bottom frame comprising a cylindrical support portion in a central region of the bottom frame; and
connection portions between the fan frames and the cylindrical support portion, the connection portions configured to connect the fan frames and the cylindrical support portion.

2. The multi-camera assembly of claim 1, wherein each of the connection portions comprises:
a ring member configured to surround an outer circumferential surface of the cylindrical support portion; and
a first fastening member extending from one side of the ring member and coupled with one of the fan frames.

3. The multi-camera assembly of claim 2, wherein the fan frames comprise a first fan frame and a second fan frame,
wherein the connection portions comprise a first connection portion and a second connection portion, the first connection portion configured to connect the first fan frame and the cylindrical support portion, and the second connection portion configured to connect the second fan frame and the cylindrical support portion, and
wherein the first fan frame and the second fan frame overlap each other on the outer circumferential surface of the cylindrical support portion.

4. The multi-camera assembly of claim 3, wherein the first fastening member of the first connection portion and the first fastening member of the second connection portion are at respective, different angles around a central axis of the cylindrical support portion, the central axis being parallel to the vertical axis.

5. The multi-camera assembly of claim 3, wherein the first connection portion and the second connection portion are coupled to the cylindrical support portion at respective, different heights based on heights at which the ring member of the first connection portion and the ring member of the second connection portion are coupled to the cylindrical support portion.

6. The multi-camera assembly of claim 2, wherein each of the fan frames comprises:
a coupling portion that is coupled to one of the connection portions; and
side portions extending from respective ends of the coupling portion and face each other to form a tilting axis of a corresponding one of the camera modules.

7. The multi-camera assembly of claim 6, wherein the coupling portion comprises a second fastening member that is configured to face and be coupled to the first fastening member.

8. The multi-camera assembly of claim 7, wherein the coupling portion further comprises a third fastening member that partially overlaps the second fastening member of the coupling portion in a height direction of the multi-camera assembly, and
wherein the third fastening member is configured to face and be coupled to the first fastening member.

9. The multi-camera assembly of claim 7, wherein the first fastening member and the second fastening member are configured to be coupled to each other via a fastener, in a state where the first fastening member and the second fastening member overlap each other in a height direction of the multi-camera assembly and are at a side of the cylindrical support portion in a radial direction of the cylindrical support portion.

10. The multi-camera assembly of claim 8, wherein the third fastening member of the coupling portion is exposed outside of the second fastening member of the coupling portion in the radial direction, and the third fastening member comprises a fastening region that is configured to be coupled to the first fastening member without interfering with the second fastening member.

11. The multi-camera assembly of claim 8, wherein the second fastening member and the third fastening member have a thickness that is the same as a thickness of the first fastening member.

12. The multi-camera assembly of claim 11, wherein the first fastening member is configured to be selectively coupled to either an upper surface or a lower surface of the second fastening member or an upper surface or a lower surface of the third fastening member.

13. The multi-camera assembly of claim 11, wherein the fan frames comprise a first fan frame and a second fan frame,
wherein the connection portions comprise a first connection portion and a second connection portion, the first connection portion configured to connect the first fan frame and the cylindrical support portion, and the second connection portion configured to connect the second fan frame and the cylindrical support portion, and
wherein the first fastening member of the first connection portion is configured to be coupled to the second fastening member or the third fastening member of the coupling portion of the first fan frame, and the first fastening member of the second connection portion is configured to be coupled to the second fastening member or the third fastening member of the coupling portion of the second fan frame, such that the first fan frame and the second fan frame are at a same height.

14. The multi-camera assembly of claim 8, wherein each connection portion from among the connection portions comprises extension members extending in a vertical direction from respective sides of the first fastening member of the connection portion, and
wherein the vertical direction is parallel to the vertical axis, and the respective sides are horizontally spaced apart from each other around the vertical axis.

15. The multi-camera assembly of claim 14, wherein the extension members of one of the connection portions are configured to interfere with the extension members of at least one other connection portion from among the connection portions, and
wherein the extension members of the least one other connection portion are in the panning direction with respect to the extension members of the one of the connection portions.

16. The multi-camera assembly of claim 14, wherein the extension members of the one of the connection portions comprise inclined surfaces, and
wherein a spacing between the inclined surfaces decreases in a direction in which the one of the connection portions is coupled to the coupling portion of one of the fan frames.

17. The multi-camera assembly of claim 16, wherein opposite side end portions of the second fastening member or the third fastening member are chamfered to correspond to a slope of the inclined surfaces.

18. A multi-camera assembly comprising:
a first camera module;
a second camera module;
a first frame configured to tiltably support the first camera module;
a second frame configured to tiltably support the second camera module;
a bottom frame configured to rotatably support the first fan frame and the second fan frame in a panning direction of the first camera module and the second camera module around a vertical axis of the bottom frame, and the bottom frame comprising a cylindrical support portion in a central region of the bottom frame;
a first connection portion between the first frame and the cylindrical support portion, the first connection portion configured to connect the first frame and the cylindrical support portion; and
a second connection portion between the second frame and the cylindrical support portion, the second connection portion configured to connect the second frame and the cylindrical support portion.

19. The multi-camera assembly of claim 18, wherein each of the first connection portion and the second connection portion comprises:
a ring member configured to surround an outer circumferential surface of the cylindrical support portion; and
a first fastening member extending from one side of the ring member and coupled with the first frame or the second frame.

20. A method of assembling a multi-camera assembly, the method comprising:
tiltably supporting camera modules on fan frames, respectively;
rotatably supporting, in a panning direction of the camera modules, the fan frames on a bottom frame, the bottom frame including a cylindrical support portion in a central region of the bottom frame; and
connecting the fan frames to the cylindrical support portion via connection portions, the connection portions being between the fan frames and the cylindrical support portion.
